(19) United States
(12) Patent Application Publication
(10) Pub. No.: US 2010/0299634 A1
(43) Pub. Date: Nov. 25, 2010

(54) METHOD FOR CONTROLLING MENU IN MOBILE TERMINAL AND MOBILE TERMINAL USING THE SAME

(75) Inventors: Seong Yoon Cho, Seoul (KR); Hye Youn Cho, Seoul (KR); Byung Sang Yeo, Seoul (KR); Yee Rang Yun, Seoul (KR); Yoo Mee Song, Seoul (KR); Dong Seok Lee, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/785,338

(22) Filed: May 21, 2010

(30) Foreign Application Priority Data
May 21, 2009 (KR) 10-2009-0044438

(51) Int. Cl. G06F 3/048; H04B 1/38

(52) U.S. Cl. 715/810; 455/566

(57) ABSTRACT

A method for controlling a menu in a mobile terminal is disclosed and the mobile terminal includes a display unit configured to display a menu configured to control the mobile terminal, the menu comprising first data, a memory configured to store the first data, an input unit configured to receive an input for accessing a preset website, a wireless communication module configured to access the preset website responsive to the input, and a controller configured to obtain second data related to the menu from the preset website and to display the menu comprising both the first data and the second data on the display unit.

### CROSS-REFERENCE TO RELATED APPLICATIONS

Pursuant to 35 U.S.C. §119(a), this application claims the benefit of earlier filing date and right of priority to the Korean Patent Application No. 10-2009-0044438, filed on May 21, 2009, the contents of which are hereby incorporated by reference herein in their entirety.

### FIELD OF THE DISCLOSURE

The present disclosure relates to a method for controlling a menu and a mobile terminal using the same.

### DISCUSSION OF THE RELATED ART

Generally, terminals can be classified into mobile/portable terminals and stationary terminals. The mobile terminals can be further classified into handheld terminals and vehicle mount terminals according to their portability.

As functions of the terminal are diversified, the terminal is implemented as a multimedia player provided with composite functions such as photographing of photos or moving pictures, playback of music or moving picture files, game play, and broadcast reception to name a few. To support the increased number of the terminal functions, structural part and/or software part of the terminal need to be improved. The recent mobile terminals have been improved to perform various functions as a multimedia player as well as basic functions such as calling.

For example, the mobile terminal may access the Internet server through a wireless communication network (also known as the mobile communication network) to display a web page. Furthermore, the mobile terminal may include a short-range wireless communication means such as Bluetooth®. The mobile terminal may transmit and receive files through the short-range wireless communication channel to/from other terminals having the short-range wireless communication means.

### SUMMARY OF THE DISCLOSURE

According to an embodiment of the present invention, a method for controlling a menu in a mobile terminal includes displaying the menu configured to control the mobile terminal, the menu comprising first data read from a memory of the mobile terminal, receiving an input for accessing a preset website, accessing the preset website responsive to the input, obtaining second data related to the menu from the preset website, and displaying the menu comprising both the first data and the second data.

According to another embodiment of the present invention, a mobile terminal includes a display unit configured to display a menu configured to control the mobile terminal, the menu comprising first data, a memory configured to store the first data, an input unit configured to receive an input for accessing a preset website, a wireless communication module configured to access the preset website responsive to the input, and a controller configured to obtain second data related to the menu from the preset website and to display the menu comprising both the first data and the second data on the display unit.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 is a block diagram of a mobile terminal according to an embodiment of the present invention.

FIG. 2A is a perspective diagram of a front-view of a mobile terminal according to an embodiment of the present invention.

FIG. 2B is a perspective diagram of a backside of the mobile terminal shown in FIG. 2A.

FIG. 3 is a flowchart illustrating controlling a menu in a mobile terminal according to an embodiment of the present invention.

FIGS. 4A-4D illustrate controlling a menu in a mobile terminal according to an embodiment of the present invention.

FIGS. 5A-5C illustrate controlling a menu in a mobile terminal according to another embodiment of the present invention.

FIGS. 6A and 6B illustrate controlling a menu in a mobile terminal according to yet another embodiment of the present invention.

FIGS. 7A-7C illustrate controlling a menu in a mobile terminal according to yet another embodiment of the present invention.

FIGS. 8A and 8B illustrate controlling a menu in a mobile terminal according to yet another embodiment of the present invention.

### DETAILED DESCRIPTION OF PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

The suffixes ‘module’, ‘unit’ and ‘part’ may be used for elements in order to facilitate the disclosure. Significant meanings or roles may not be given to the suffixes themselves and it is understood that the ‘module’, ‘unit’ and ‘part’ may be used together or interchangeably.

Embodiments of the present invention may be applicable to various types of terminals. Examples of such terminals may include mobile terminals as well as stationary terminals, such as mobile phones, user equipment, smart phones, DTV, computers, digital broadcast terminals, personal digital assistants, portable multimedia players (PMP) and/or navigators. A further description may be provided with regard to a mobile terminal, although such teachings may apply equally to other types of terminals.

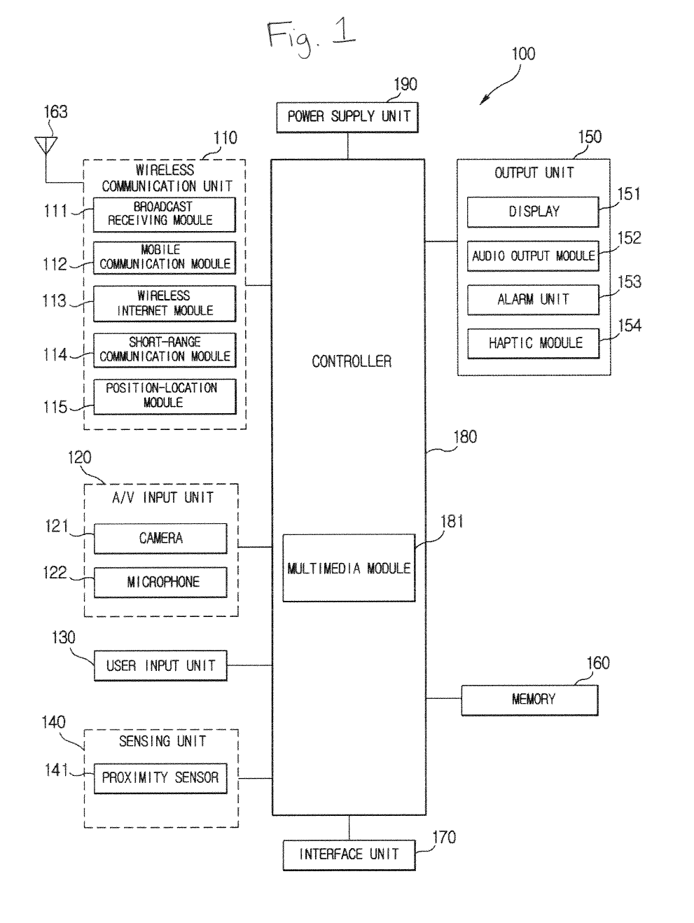

FIG. 1 is a block diagram of a mobile terminal 100 in accordance with an embodiment of the present invention. Alternative embodiments and arrangements may also be implemented. FIG. 1 shows a mobile terminal 100 having various components including a wireless communication unit 110, an audio/video (A/V) input unit 120, a user input unit 130, a sensing unit 140, an output unit 150, a memory 160, an interface unit 170, a controller 180, and a power supply 190. Additional or less components may alternatively be implemented in the mobile terminal 100 as necessary.

The wireless communication unit 110 may be configured with several components and/or modules. For example, the wireless communication unit 110 includes a broadcast receiving module 111, a mobile communication module 112, a wireless Internet module 113, a short-range communication module 114 and a position-information module 115. The wireless communication unit 110 may also include one or more components that permit wireless communication between the mobile terminal 100 and a wireless communication system or a network within which the mobile terminal 100 is located. In case of non-mobile terminals, the wireless communication unit 110 may be replaced with a wired communication unit. The wireless communication unit 110 and the wired communication unit may be commonly referred to as a communication unit.

In one aspect of the present invention, the broadcast receiving module 111 receives a broadcast signal and/or broadcast associated information from an external broadcast managing entity via a broadcast channel. For example, the broadcast channel includes a satellite channel and a terrestrial channel. The broadcast managing entity may refer to a system that transmits a broadcast signal and/or broadcast associated information.

Examples of broadcast associated information include information associated with a broadcast channel, a broadcast program, and a broadcast service provider. For example, broadcast associated information includes an electronic program guide (EPG) of digital multimedia broadcasting (DMB) and an electronic service guide (ESG) of digital video broadcast-handheld (DVB-H).

At least two broadcast receiving modules 111 may be provided in the mobile terminal 100 to pursue simultaneous reception of at least two broadcast channels or facilitation of broadcast channel switching. The broadcast signal may be a TV broadcast signal, a radio broadcast signal, and/or a data broadcast signal. The broadcast signal may further include a broadcast signal combined with a TV or radio broadcast signal.

The broadcast receiving module 111 receives broadcast signals transmitted from various types of broadcast systems. As a non-limiting example, the broadcasting systems may include digital multimedia broadcasting-terrestrial (DMB-T), digital multimedia broadcasting-satellite (DMB-S), digital video broadcast-handheld (DVB-H), a data broadcasting system known as media forward link only (MediaFLO®) and integrated services digital broadcast-terrestrial (ISDB-T). The receiving of multicast signals may also be provided. Data received by the broadcast receiving module 111 may be stored in the memory 160, for example.

The mobile communication module 112 may communicate wireless signals with one or more network entities (e.g. a base station or Node-B). For example, the signals may represent audio, video, multimedia, control signaling, or data.

The wireless Internet module 113 supports Internet access for the mobile terminal 100. This wireless Internet module 113 may be internally or externally coupled to the mobile terminal 100. Suitable technologies for wireless Internet may include, but are not limited to, WLAN (Wireless LAN)(Wi-Fi), Wibro (Wireless broadband), Wimax (World Interoperability for Microwave Access), and/or HSDPA (High Speed Downlink Packet Access). The wireless Internet module 113 may be replaced with a wired Internet module in non-mobile terminals. The wireless Internet module 113 and the wired Internet module may be referred to as an Internet module.

The short-range communication module 114 facilitates short-range communications. Suitable technologies for short-range communication may include, but are not limited to, radio frequency identification (RFID), infrared data association (IrDA), ultrawideband (UWB), as well as networking technologies such as Bluetooth® and ZigBee®.

The position-information module 115 identifies or otherwise obtains a location of the mobile terminal 100. The position-information module 115 may be provided using global positioning system (GPS) components that cooperate with associated satellites, network components, and/or combinations thereof.

The position-information module 115 may precisely calculate current 3-dimensional position information based on longitude, latitude and altitude by calculating distance information and precise time information from at least three satellites and then by applying triangulation to the calculated information. Location and time information may be calculated using three satellites, and errors of the calculated location position and time information may then be amended or changed using another satellite. The position-information module 115 may calculate speed information by continuously calculating a real-time current location.

The audio/video (A/V) input unit 120 provides audio or video signal input to the mobile terminal 100. The A/V input unit 120 may include a camera 121 and a microphone 122. The camera 121 may receive and process image frames of still pictures and/or video.

The microphone 122 may receive an external audio signal while the mobile terminal 100 is in a particular mode, such as a phone call mode, a recording mode and/or a voice recognition mode. The received audio signal may then be processed and converted into digital data.

The mobile terminal 100, and in particular the A/V input unit 120, may include a noise removing algorithm (or noise canceling algorithm) to remove noise generated in the course of receiving the external audio signal. Data generated by the A/V input unit 120 may be stored in the memory 160, utilized by the output unit 150, and/or transmitted via one or more modules of the wireless communication unit 110. Two or more microphones 122 and/or cameras 121 may also be provided.

The user input unit 130 generates input data responsive to user manipulation of an associated input device or devices. Examples of such devices include a keypad, a dome switch, a touchpad (e.g., static pressure/capacitance), a jog wheel and/or a jog switch. Another example is one in which the user input unit 130 is configured as a touchpad in cooperation with a display, as will be described below.

The sensing unit 140 provides status measurements of various aspects of the mobile terminal 100. For example, the sensing unit 140 detects an open/close status of the mobile terminal 100, a relative positioning of components (e.g., a display and a keypad) of the mobile terminal 100, a change of position of the mobile terminal 100 or a component of the mobile terminal 100, a presence or absence of user contact with the mobile terminal 100, and/or an orientation or acceleration/deceleration of the mobile terminal 100.

The mobile terminal 100 may be configured as a slide-type mobile terminal. In such a configuration, the sensing unit 140 may sense whether a sliding portion of the mobile terminal 100 is open or closed. The sensing unit 140 may also sense presence or absence of power provided by the power supply 190 and presence or absence of a coupling or other connection between the interface unit 170 and an external device. The sensing unit 140 may include a proximity sensor 141.

The output unit 150 generates an output relevant to, for example, a sight sense, an auditory sense, or a tactile sense. The output unit 150 may include a display 151, an audio output module 152, an alarm 153, and a haptic module 154.

The display 151 may output or display information processed by the mobile terminal 100. For example, in case that the mobile terminal 100 is in a call mode, the display 151 displays a user interface (UI) or a graphic user interface (GUI) associated with the call. If the mobile terminal 100 is in a video communication mode or a photograph mode, the display 151 displays a photographed and/or received picture, a UI or a GUI.

The display 151 may include at least one of a liquid crystal display (LCD), a thin film transistor liquid crystal display (TFT LCD), an organic light-emitting diode (OLED), a flexible display, and a 3-dimensional display. The display 151 may have a transparent or light-transmittive type configuration to enable an external environment to be seen through. This may be called a transparent display. A transparent OLED (TOLED) is an example of a transparent display. A backside structure of the display 151 may also have the light-transmittive type configuration. In this configuration, a user may see an object located behind the terminal body through the area occupied by the display 151 of the terminal body.

At least two displays 151 may also be provided. For example, a plurality of displays 151 may be provided on a single face of the mobile terminal 100 by being built in one body or spaced apart from the single face. Alternatively, each of a plurality of displays 151 may be provided on different faces of the mobile terminal 100.

If the display 151 and a sensor for detecting a touch action (hereafter a touch sensor) are constructed in a mutual-layered structure (hereafter a touchscreen), the display 151 may be used as an input device as well as an output device. For example, the touch sensor includes a touch film, a touch sheet, or a touchpad.

The touch sensor may convert a pressure applied to a specific portion of the display 151 or a variation of electrostatic capacity generated from a specific portion of the display 151 to an electric input signal. The touch sensor may detect a pressure of a touch as well as a position and size of the touch.

If a touch input is provided to the touch sensor, signal(s) corresponding to the touch input may be transferred to a touch controller. The touch controller may process the signal(s) and then transfer corresponding data to the controller 180. The controller 180 may therefore know which portion of the display 151 is touched.

FIG. 1 shows that the proximity sensor 141 can be provided within the mobile terminal 100 enclosed by the touchscreen or around the touchscreen. The proximity sensor 141 may detect a presence or non-presence of an object approaching a prescribed detecting surface or an object existing around the proximity sensor 141 using an electromagnetic field strength or infrared ray without mechanical contact. The proximity sensor 141 may have a longer durability than the contact type sensor and may also have a greater usage than the contact type sensor.

The proximity sensor 141 may include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, or an infrared proximity sensor. If the touchscreen is an electrostatic type, the proximity sensor 141 may detect proximity of a pointer using a variation of an electric field according to the proximity of the pointer. In this case, the touchscreen (touch sensor) may be classified into the proximity sensor 141.

An action in which a pointer approaches the touchscreen without contacting the touchscreen may be called a proximity touch. An action in which a pointer actually touches the touchscreen may be called a contact touch. The location of the touchscreen proximity-touched by the pointer may be the position of the pointer that vertically opposes the touchscreen when the pointer performs the proximity touch.

The proximity sensor 141 may detect a proximity touch and/or a proximity touch pattern (e.g., a proximity touch distance, a proximity touch duration, a proximity touch position, or a proximity touch shift state). Information corresponding to the detected proximity touch action and/or the detected proximity touch pattern may be output to the touchscreen.

The audio output module 152 outputs audio data that is received from the wireless communication unit 110 in a call signal reception mode, a call mode, a recording mode, a voice recognition mode, or a broadcast receiving mode. The audio output module 152 may output audio data stored in the memory 160. The audio output module 152 may output an audio signal relevant to a function (e.g., a call signal receiving sound, a message receiving sound, etc.) performed by the mobile terminal 100. The audio output module 152 may include a receiver, a speaker, or a buzzer.

The alarm 153 outputs a signal for announcing an event occurrence of the mobile terminal 100. An event occurring in the mobile terminal 100 may include one of a call signal reception, a message reception, a key signal input, or a touch input. The alarm 153 may output a signal for announcing an event occurrence by way of vibration as well as a video signal or an audio signal. The video signal may be output via the display 151. The audio signal may be output via the audio output module 152. The display 151 or the audio output module 152 may be classified as part of the alarm 153.

The haptic module 154 brings about various haptic effects that can be sensed by a user. Vibration is a representative example for the haptic effect brought about by the haptic module 154. Strength and pattern of the vibration generated from the haptic module 154 may be controllable. For example, vibrations differing from each other may be output in a manner of being synthesized together or may be sequentially output.

The haptic module 154 may generate various haptic effects including a vibration, an effect caused by such a stimulus as a pin array vertically moving against a contact skin surface, a jet power of air via outlet, a suction power of air via inlet, a skim on a skin surface, a contact of an electrode, or an electrostatic power and/or an effect by hot/cold sense reproduction using an endothermic or exothermic device as well as the vibration.

The haptic module 154 may provide the haptic effect via direct contact. The haptic module 154 may enable a user to experience the haptic effect via muscular sense of a finger or an arm. Two or more haptic modules 154 may be provided according to a configuration of the mobile terminal 100.

The memory 160 may store a program for operations of the controller 180. The memory 160 may temporarily store input/output data (e.g., phonebook, message, still picture, or moving picture). The memory 160 may store data of vibration and sound in various patterns output in case of a touch input to the touchscreen.

The memory 160 may include at least one of a flash memory, a hard disk, a multimedia card micro type memory, a card type memory (e.g., SD memory or XD memory), a random access memory (RAM), a static random access memory (SRAM), a read-only memory (ROM), an electrically erasable programmable read-only memory, a programmable read-only memory, a magnetic memory, a magnetic disk, or an optical disk. The mobile terminal 100 may operate in association with a web storage that performs a storage function of the memory 160 via the Internet.

The interface unit 170 may play a role as a passage to external devices connected to the mobile terminal 100. The interface unit 170 may receive data from an external device. The interface unit 170 may be supplied with a power and then the power may be delivered to elements within the mobile terminal 100. The interface unit 170 may enable data to be transferred to an external device from an inside of the mobile terminal 100. The interface unit 170 may include a wire/wireless headset port, an external charger port, a wire/wireless data port, a memory card port, a port for coupling to a device having an identity module, an audio input/output (I/O) port, a video input/output (I/O) port, or an earphone port.

The identity module may be a chip or card that stores various kinds of information for authenticating use of the mobile terminal 100. The identify module may include a user identity module (UIM), a subscriber identity module (SIM), or a universal subscriber identity module (USIM). A device provided with the above identity module (hereafter an identity device) may be manufactured in the form of a smart card. The identity device may be connected to the mobile terminal 100 via the port.

The interface unit 170 may play a role as a passage for supplying a power to the mobile terminal 100 from a cradle that is connected to the mobile terminal 100. The interface unit 170 may play a role as a passage for delivering various command signals, which are input from the cradle by a user, to the mobile terminal 100. Various command signals input from the cradle or the power may work as a signal for recognizing that the mobile terminal 100 is correctly loaded in the cradle.

The controller 180 controls overall operations of the mobile terminal 100. For example, the controller 180 controls and processes a voice call, a data communication, or a video conference. The controller 180 may have a multimedia module 181 for multimedia playback. The multimedia module 181 may be implemented within the controller 180 or may be configured separate from the controller 180. The controller 180 may perform pattern recognizing processing for recognizing a handwriting input performed on the touchscreen as a character and/or recognizing a picture drawing input performed on the touchscreen as an image.

The power supply 190 may receive an external or internal power and then supply the power required for operations of the respective elements under control of the controller 180.

Embodiments of the present invention explained in the following description may be implemented within a recording medium that can be read by a computer or a computer-like device using software, hardware or combination thereof.

According to the hardware implementation, arrangements and embodiments may be implemented using at least one of application specific integrated circuits (ASICs), digital signal processors (DSPs), digital signal processing devices DSPDs), programmable logic devices (PLDs), field programmable gate arrays (FPGAs), processors, controllers, microcontrollers, microprocessors and electrical units for performing other functions. In some cases, embodiments may be implemented by the controller 180.

For a software implementation, arrangements and embodiments described herein may be implemented with separate software modules, such as procedures and functions, each of which may perform one or more of the functions and operations described herein. Software codes may be implemented with a software application written in any suitable programming language and may be stored in memory such as the memory 160, and may be executed by a controller or processor, such as the controller 180.

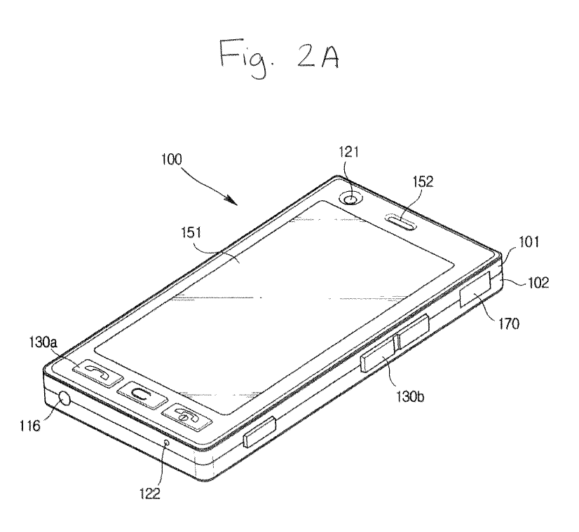

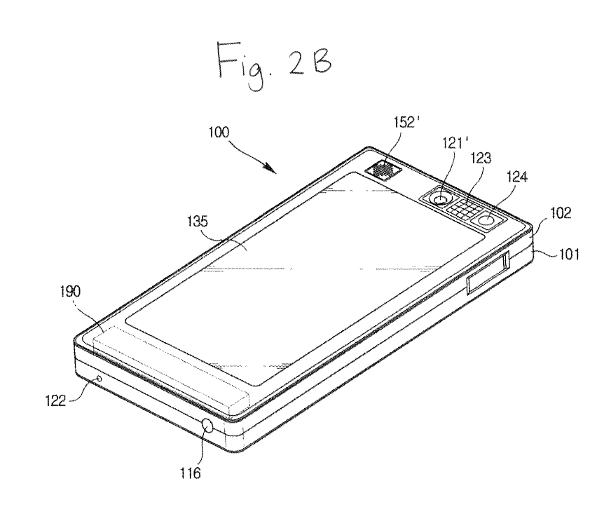

FIG. 2A is a perspective diagram of a front-view of a mobile terminal according to an embodiment of the present invention. Alternative embodiments, configurations and arrangements may also be provided. As shown in FIG. 2A, the mobile terminal 100 may include a bar type terminal body. Embodiments of the mobile terminal 100 may be implemented in a variety of different configurations. Examples of such configurations may include a folder-type, a slide-type, a bar-type, a rotational-type, a swing-type and/or combinations thereof.

The body may include a case, such as casing, housing, or cover, that forms an exterior of the mobile terminal 100. The case may be divided into a front case 101 and a rear case 102. Various electric/electronic parts may be provided in a space between the front case 101 and the rear case 102. A middle case may be further provided between the front case 101 and the rear case 102. The cases 101, 102 may be formed by injection molding of synthetic resin or may be formed of metal substance such as stainless steel (STS) or titanium (Ti) for example.

The display 151, the audio output unit 152, the camera 121, user input units 130 (130a and 130b), the microphone 122, or the interface unit 170 may be provided on the terminal body, and more particularly on the front case 101. The display 151 may occupy most of a main face of the front case 101. The audio output module 152 and the camera 121 may be provided at an area adjacent to one end portion of the display 151, while a first user input unit 130a and the microphone 122 may be provided at another area adjacent to the other end portion of the display 151. The user second input unit 130b and the interface unit 170 may be provided on lateral sides of the front and rear cases 101 and 102.

The user input unit 130 may receive a command for controlling an operation of the mobile terminal 100. The user input unit 130 may include a plurality of manipulating units 130a and 130b. The manipulating units 130a and 130b may be called a manipulating portion and may adopt any mechanism of a tactile manner that enables a user to perform a manipulation action by experiencing a tactile feeling.

Content input by the first manipulating unit 130a or the second manipulating unit 130b may be diversely set. For example, a command such as start, end, or scroll may be input to the first manipulating unit 130a. A command for a volume adjustment of sound output from the audio output unit 152 or a command for a switching to a touch recognizing mode of the display 151 may be input to the second manipulating unit 130b.

FIG. 2B is a perspective diagram of a backside of the mobile terminal 100 shown in FIG. 2A. Alternative embodiments, configurations and arrangements may also be provided.

As shown in FIG. 2B, a second camera 121′ may be additionally provided on a backside of the terminal body, and more particularly on the rear case 102. The second camera 121′ may have a photographing direction that is substantially opposite to a photographing direction of the camera 121 (shown in FIG. 2A) and may have pixels differing from pixels of the first camera 121.

For example, the first camera 121 may have a lower resolution and transmit a picture of user's face with a lower number of pixels for a video call, while the second camera 121′ may have a higher resolution for capturing a general subject for photography without transmitting the captured subject image in a greater number of pixels. Each of the cameras 121 and 121′ may be installed on the terminal body to be rotated and/or popped up.

A flash 123 and a mirror 124 may be additionally provided adjacent to the camera 121′. The flash 123 may project light toward a subject in case of photographing the subject using the camera 121′. If a user attempts to take a picture of the user (self-photography) using the camera 121′, the mirror 124 may enable the user to view a user's face reflected by the mirror 124.

An additional audio output unit 152′ may be provided on the backside of the terminal body. An additional audio output unit 152′ may implement a stereo function together with the audio output unit 152 shown in FIG. 2A and may be used for implementation of a speakerphone mode in talking over the terminal.

A broadcast signal receiving antenna 116 may be additionally provided at the lateral side of the terminal body as well as an antenna for communication. The antenna 116 may be considered a portion of the broadcast receiving module 111 shown in FIG. 1 and may be retractably provided on the terminal body.

The power supply 190 for supplying a power to the mobile terminal 100 may be provided on the terminal body. The power supply 190 may be built within the terminal body. Alternatively, the power supply 190 may be detachably connected to the terminal body.

FIG. 2B also shows a touchpad 135 for detecting a touch that is additionally provided on the rear case 102. The touchpad 135 may be configured in a light transmittive type like the display 151. If the display 151 outputs visual information from both faces, the display 151 may recognize visual information via the touchpad 135 as well. The information output from both of the faces may be controlled by the touchpad 135. Alternatively, a second display may be further provided on the touchpad 135 so that a touchscreen may also be provided on the rear case 102.

The touchpad 135 may be activated by interconnecting with the display 151 of the front case 101. The touchpad 135 may be provided behind the display 151 such that they are parallel to one another. The touchpad 135 may have a size equal to or less than a size of the display 151.

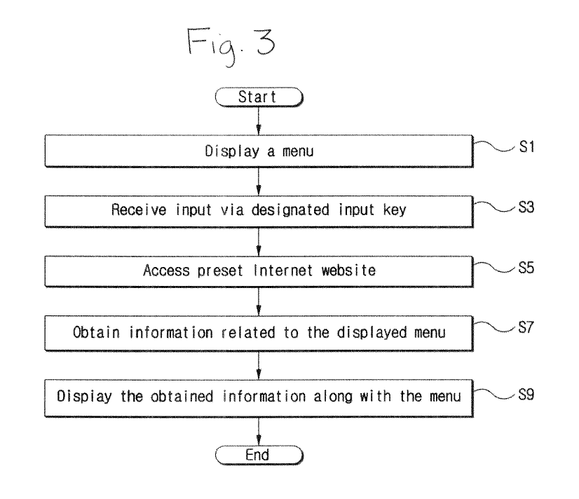

In the following description, a method for controlling a menu in a mobile terminal 100 according to an embodiment of the present invention is explained by referring to FIG. 3. As shown in FIG. 3, the mobile terminal 100 displays a menu on the display unit 151 (S1) in response to a user input received via the user input unit 130, wherein the menu is stored in the memory 160 of the mobile terminal 100. The menu may include an idle screen, a contact list, and a gallery. When the menu is displayed, an input is received when a designated input key or access key is pressed in order to access a preset website (S3).

In one aspect of the present invention, the designated input key is for directly accessing a private blog or mini home page such as Cyworld® and My Space®. The side key may be used as the designated input key. The preset Internet website may also be accessed by a general method known in the art.

Once the designated input key is pressed, the controller 180 activates the wireless communication module 110 to access the preset Internet website (S5). For example, the preset Internet website is an SNS (Social Network Service) site. In one aspect of the present invention, once the preset Internet website is accessed, the user is automatically logged on to the preset Internet website using the log-on information that is stored in the memory 160.

A plurality of Internet websites may also be set up for the designated input key. Alternatively, the Internet websites may be restricted only to sites that relate to the user.

For example, even though the user of the mobile terminal 100 may set up an Internet website to access, a manager of the website may restrict the mobile terminal 100 from accessing the website. In this case, a message may be received through the wireless communication module 110 of the mobile terminal 100, wherein the message informs the user that access to the website is restricted.

Once the mobile terminal 100 accesses the Internet website, the controller 180 obtains information related to the menu displayed on the display unit 151 from the accessed Internet website (S7). For example, if the menu displayed on the display unit 151 is a contact list including contact information stored in the memory 160, the information obtained from the Internet website may be contact information with regard to the Internet website. Accordingly, the information obtained through the wireless communication module 110 of the mobile terminal 100 may be displayed along with the menu previously being displayed (S9) or the obtained information may be integrated into the displayed menu to further display an extended contact list including the contact information with regard to the Internet website.

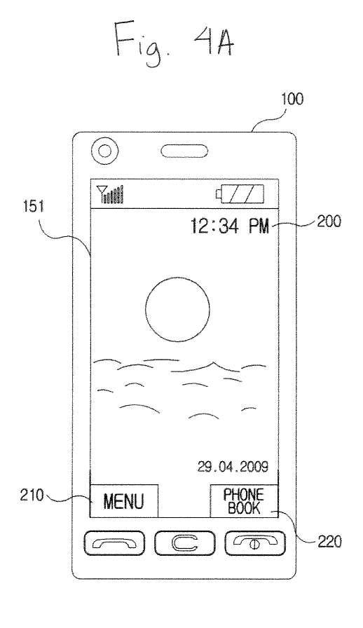

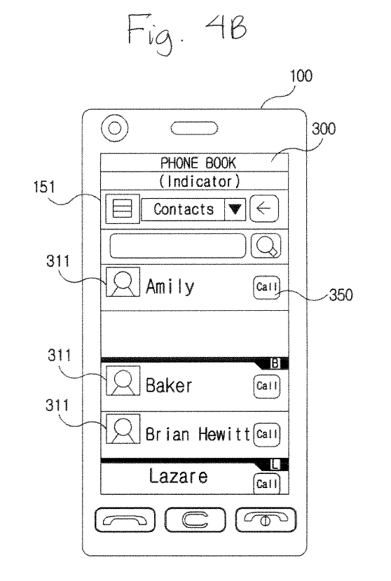

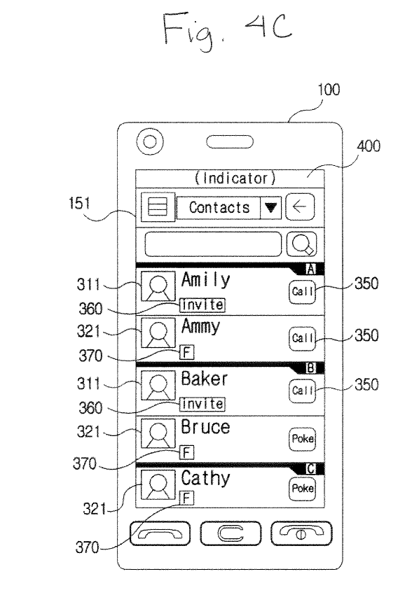

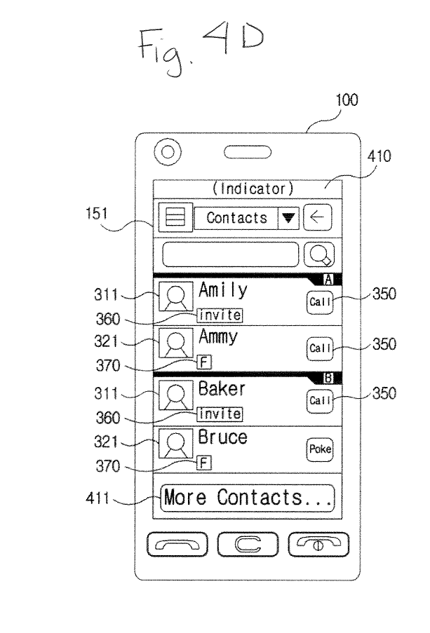

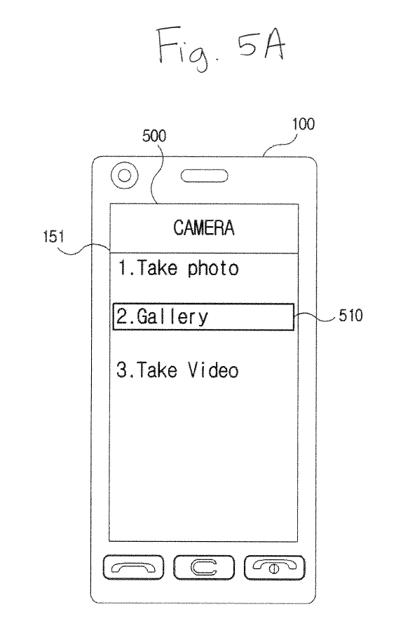

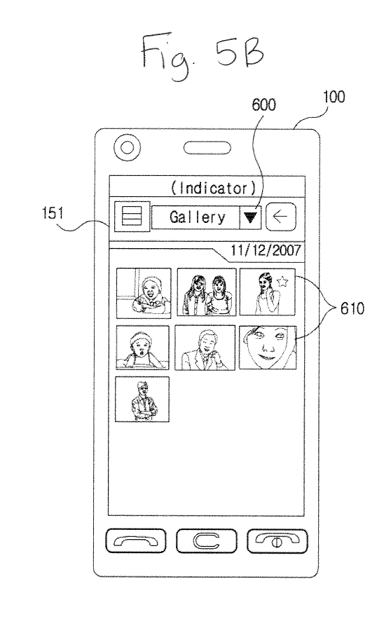

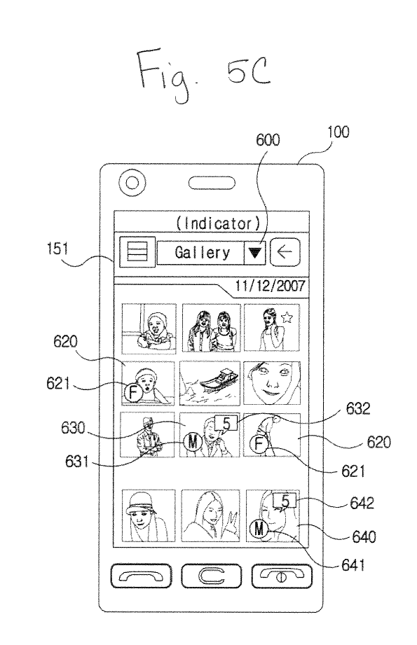

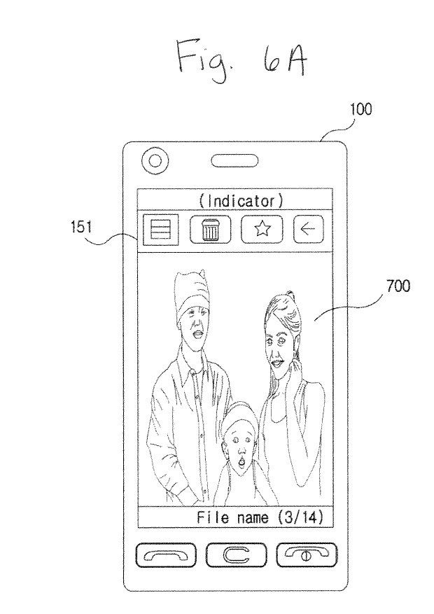

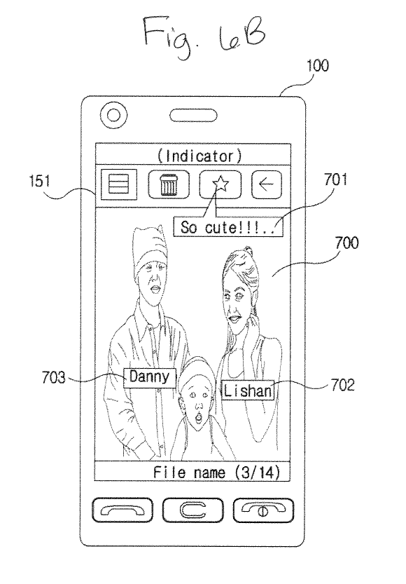

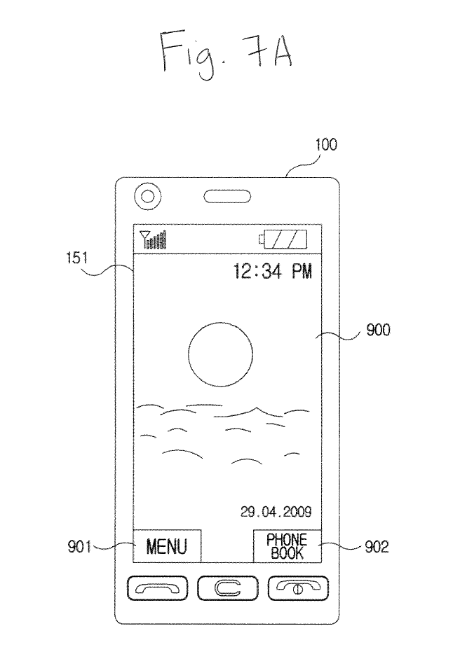

The user may execute a function provided from the Internet website by controlling the menu displayed on the display unit 151. For example, an invitation function provided from the accessed Internet website may be integrated into the contact list as shown in FIGS. 4C and 4D. More examples of menu controlling will be explained in the following description referring to FIG. 4A to 8B.

Besides the input received or entered via the designated input key or access key, if the user sets up a predetermined area for accessing the preset Internet website and the mobile terminal 100 enters the predetermined area, the position-information module 115 may detect the predetermined area. In turn, the controller 180 activates the wireless communication module 110 to access the predetermined Internet website.

Alternatively, if the user initiates a menu related to a menu downloaded from the Internet website and stored in the memory 160 according to the user's set-up, the stored downloaded menu may be displayed with the original menu. In one aspect of the present invention, the mobile terminal 100 may access the Internet website periodically to display the changed items of the menu on the display unit 151 in real time by downloading the information related to the menu based on the user's set-up. The alarm 153 may inform the user of the change in the information.

According to an embodiment of the present invention, the user may obtain the information of the Internet website. Moreover, the user may execute a function provided by the Internet website through the mobile terminal 100.

Referring to FIG. 4A, an idle screen 200 is displayed on the display 151 of the mobile terminal 100. The idle screen 200 includes a menu icon 210 and a phone book icon 220. When the user select the phone book icon 220 via the user input unit 130 or the touchscreen, a phone book screen 300 is displayed on the display unit 151, as illustrated in FIG. 4B.

The phone book lists contact information 311 on the phone book screen 300. Each contact information 311 listed in the phone book has a “call” icon 350. If the display unit 151 is a touch screen, an attempt to call may be made by directly touching the call icon 350.

While the phone book is displayed, if the SNS access key is pressed, the phone book screen 300 of FIG. 4B is changed to the phone book screen 400 of FIG. 4C. The phone book screen 400 in FIG. 4C is a composite phone book in which the contact information stored in the memory 160 of the mobile terminal 100 and the contact information stored in a server are displayed together.

Two different types of contact information 311 and 321 are included in the composite phone book screen 400. A site icon 370 showing the origin of the contact information is included in each contact information 321 that is originated from the server. Moreover, an invitation icon 360 is displayed for each contact information 311 that is not originated from the server but is stored in the memory 160.

The invitation function is one of the functions provided from the Internet website. Accordingly, if the invitation icon 360 is selected from the contact information 311 listed in the phone book, the invitation function of the Internet website is executed by using an e-mail address included in the contact information 311. Alternatively, if the phone number data is also included in the contact information, the attempt to call may be made by selecting the call icon 350 included in the contact information 311, 321.

FIG. 4D illustrates another embodiment of the composite phone book. An additional view icon 411 is displayed on the composite phone book screen 410. Here, the additional view icon 411 is selected to show additional contact information included in the phone book. According to the above described embodiment of the present invention, the user can easily obtain the contact information from the preset Internet website and the user can place a call through the phone book listing the contact information.

FIG. 5A illustrates a camera menu screen 500 of the mobile terminal 100 according to an embodiment of the present invention. If the user selects a gallery icon 510 included in the camera menu screen 500 via the user input unit 130, a gallery screen 600 is displayed on the display unit 151, as shown in FIG. 5B.

The gallery screen 600 includes a plurality of the thumbnail images 610. If the SNS access key is pressed while the gallery screen 600 is displayed, the controller 180 activates the wireless communication module 110 to download the images 620, 630, 640 from the preset Internet website. Then, the controller 180 displays all the images 620, 630, 640 as thumbnail images. Icons 621, 631, 641 showing the origin of the images may be displayed with the thumbnail images, as shown in FIG. 5C.

The user may store an image in the memory 160 of the mobile terminal 100 by selecting a thumbnail image. Alternatively, if the images are downloaded from a plurality of websites, only images downloaded from a specific website may be displayed, according to the user's set-up.

For example, if Myspace® icon 631 is selected, the image 630 from Myspace® is displayed on the display unit 151. Alternatively, Myspace® may be selected through a specific menu.

The thumbnail images 630, 640 may also include reply number icons 632, 642 showing a number of the replies related to the images 630, 640. If the user selects the reply number icon 632, 642, the replies are displayed on the display unit 151. According to the above described embodiment of the present invention, the user of the mobile terminal 100 can easily download images from the preset Internet website.

FIG. 6A illustrates displaying an image 700 downloaded from the Internet website on the display unit 151. While the image 700 is displayed on the display unit 151, if the SNS access key is pressed, the controller 180 activates the wireless communication module 110 to access the website which is an origin of the displayed image. At this time, the tag information of the website included in the image file may be used. If the website is accessed, footers 701, 702, 703 stored in the website are displayed on the displayed image 700, as illustrated in FIG. 6B. If the footers 701, 702, 703 are hyperlinked, when the user selects the footer, the controller 180 accesses the hyperlinked website to display the website on the display unit 151. According to the above described embodiment of the present invention, the user can access extra information related to the image 700 when the information obtained from the preset website is displayed along with the image stored in the memory 160.

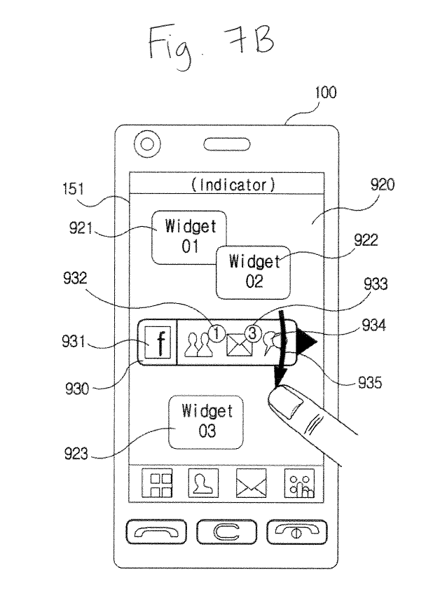

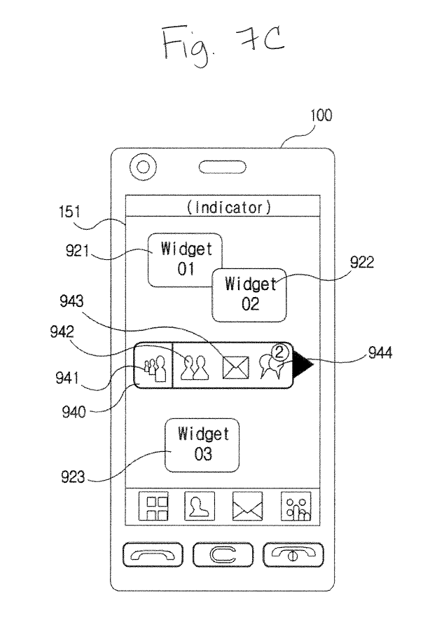

FIG. 7A illustrates an idle screen 900 displayed on the display 151 of the mobile terminal 100. The idle screen 900 may include a menu icon 901 and a phone book icon 902. If the SNS access key is pressed while the idle screen 900 is displayed, the controller 180 accesses an Internet website which was previously set up. Then, the composite idle screen 920 is displayed on the display unit 151, as shown in FIG. 7B.

The composite idle screen 920 includes widgets 921, 922, 923 provided from the preset Internet website and a first tool bar 930. The widgets 921, 922, 923 may include a clock, a bubble word, an avatar and an image. The first tool bar 930 may include an origin icon 931 for indicating the origin of the first tool bar 930, a friend icon 932 for indicating a logged-on friend, a new message icon 933 for showing a new message, and a new reply icon 934 for showing a new reply.

When the friend icon 932 is selected through the user input unit 130, a list of the friends who are logged on to the preset Internet website is displayed on the display unit 151. When the new message icon 933 is selected, the controller 180 opens the message to which a new reply is added, or to a gallery to which a new reply is added.

If a tool bar change signal is generated on the first tool bar 930, a second tool bar 940 is displayed, as shown in FIG. 7C. The tool bar change signal may be generated in response to scrolling of the first tool bar 930 on the touch screen as indicated by the arrow mark 935 in FIG. 7B. Alternatively, the tool bar change signal may be generated in response to an input received via the user input unit 130.

The second tool bar 940 may include an origin icon 941 for indicating the origin of the tool bar, a friend icon 942 for indicating logged-on friends, a new message icon 943 for showing a new message, and a new reply icon 944 for showing a new reply. The icons 941, 942, 943, 944 included in the second bar 940 have the same or similar functions as the functions of the icons 931, 932, 933, 934 included in the first tool bar 930. According to the above discussed embodiment of the present invention, the user can easily access the SNS website from the idle screen of the mobile terminal 100 and use the SNS service available from the SNS website.

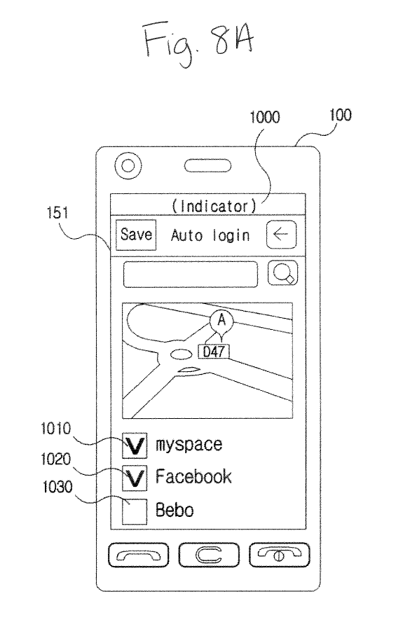

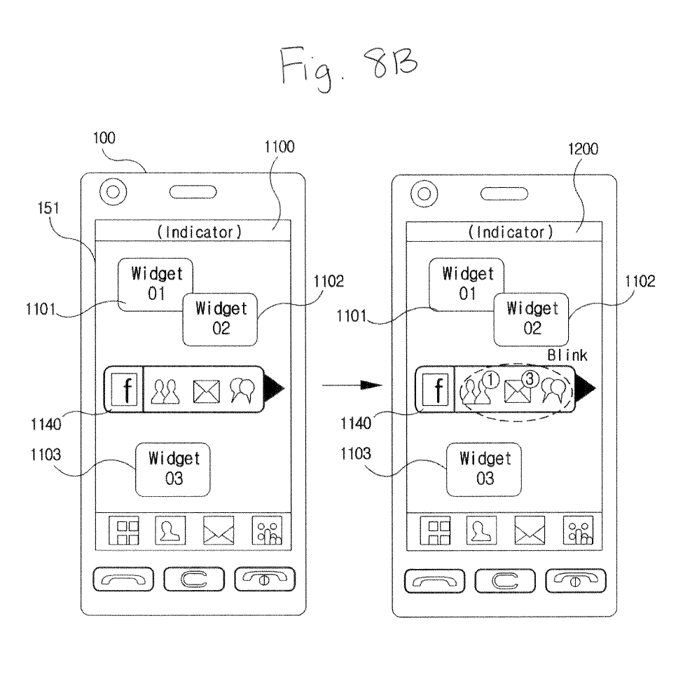

FIG. 8A illustrates a screen for setting up a condition for accessing the SNS Internet website. FIG. 8A shows an SNS area set-up screen 1000 for setting up activation of an SNS according to a location of the mobile terminal 100. As shown in FIG. 8A, map data for setting up the area is displayed on the display unit 151. The SNS website set-up icons 1010, 1020, 1030 are displayed on the display unit 151. If at least one of the website set-up icons 1010, 1020, 1030 is selected, the controller 180 obtains information from the corresponding at least one selected SNS website and displays the information related to the selected SNS on the screen. In one aspect of the present invention, the mobile terminal 100 may be set up to access the at least one selected SNS website with pre-stored auto login information when the mobile terminal 100 is located in the set area.

The information related to the selected SNS may include a widget 1101, 1102, 1103 and a tool bar 1140, as shown in FIG. 8B. The condition for accessing the SNS website may be set up and a specific SNS may be selected by using the map data and a specific menu. After completing the set-up, if the mobile terminal 100 enters a certain area which satisfies the condition, the controller 180 automatically activates the wireless communication module 110 to access the selected SNS website, and displays the composite idle screen 1100 illustrated in FIG. 8B on the display unit 151 by obtaining information for an idle screen from the SNS website.

As illustrated in FIG. 8B, an updated composite idle screen 1200 is displayed when a new message is received at the Internet website or when a new reply is received at the Internet website, the tool bar displaying the changed information. In particular, icons in the tool bar with changes may alert the user, for example, by blinking the icons.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for controlling a menu in a mobile terminal, the method comprising:
displaying the menu configured to control the mobile terminal, the menu comprising first data read from a memory of the mobile terminal;
receiving an input for accessing a preset website;
accessing the preset website responsive to the input;
obtaining second data related to the menu from the preset website; and
displaying the menu comprising both the first data and the second data.

2. The method of claim 1, wherein the input is received via a designated input key for accessing the preset website or the input is generated upon entering a preset area detected by a position information module of the mobile terminal.

3. The method of claim 1, further comprising:
selecting a menu item from the menu, the menu item related to the second data.

4. The method of claim 3, further comprising:
displaying information provided from the preset website in response to the selection of the menu item.

5. The method of claim 1, further comprising:
automatically logging on to the preset website using pre-stored log-in information for the preset website upon accessing the preset website.

6. The method of claim 1, wherein the menu comprises a contact list, the first data comprises contact information stored in the mobile terminal, and the second data comprises contact information obtained from the present website.

7. The method of claim 1, further comprising:
executing a function provided from the preset website by selecting the second data from the menu.

8. The method of claim 1, wherein the menu comprises a gallery including a plurality of images, the first data comprises an image file stored in the mobile terminal, and the second data comprises an image file obtained from the preset website, the first data and the second data displayed as at least two of the plurality of images.

9. The method of claim 8, wherein the second data further comprises additional information obtained from the preset website and the second data is distinguishable from the first data in the gallery.

10. The method of claim 9, further comprising:
executing a function provided from the preset website by selecting the second data from the menu.

11. A mobile terminal comprising:
a display unit configured to display a menu configured to control the mobile terminal, the menu comprising first data;
a memory configured to store the first data;
an input unit configured to receive an input for accessing a preset website;
a wireless communication module configured to access the preset website responsive to the input; and
a controller configured to obtain second data related to the menu from the preset website and to display the menu comprising both the first data and the second data on the display unit.

12. The mobile terminal of the claim 11, further comprising a position information module configured to detect a preset area in which the mobile terminal is located, wherein the controller is further configured to access the preset website upon entering the preset area.

13. The mobile terminal of the claim 11, wherein the controller is further configured to select a menu item from the menu, the menu item related to the second data.

14. The mobile terminal of the claim 13, wherein the controller is further configured to display information provided from the preset website in response to the selection of the menu item.

15. The mobile terminal of the claim 11, wherein the controller is further configured to automatically log on to the preset website using pre-stored log-in information for the preset website upon accessing the preset website.

16. The mobile terminal of the claim 11, wherein the menu comprises a contact list, the first data comprises contact information stored in the mobile terminal, and the second data comprises contact information obtained from the present website.

17. The mobile terminal of the claim 11, the controller is further configured to execute a function provided from the preset website in response to selection of the second data from the menu.

18. The mobile terminal of the claim 11, wherein the menu comprises a gallery including a plurality of images, the first data comprises an image file stored in the mobile terminal, and the second data comprises an image file obtained from the preset website, the first data and the second data displayed as at least two of the plurality of images.

19. The mobile terminal of the claim 18, wherein the second data further comprises additional information obtained from the preset website and the second data is distinguishable from the first data in the gallery.

20. The mobile terminal of the claim 19, wherein the controller is further configured to execute a function provided from the preset website in response to selection of the second data from the menu.
